(19) United States
(12) Patent Application Publication
(10) Pub. No.: US 2015/0202945 A1
(43) Pub. Date: Jul. 23, 2015

(54) REFRIGERATED TRAILER AIRFLOW SUPPLY DUCT

(71) Applicant: Carrier Corporation, Farmington, CT (US)

(72) Inventors: Peter R. Bushnell, Cazenovia, NY (US); Richie C. Stauter, Fayetteville, NY (US); Dale Fine, Cicero, NY (US)

(21) Appl. No.: 14/422,964

(22) PCT Filed: Aug. 7, 2013
(86) PCT No.: PCT/US13/53892

§ 371 Date: Feb. 20, 2015

Related U.S. Application Data
(60) Provisional application No. 61/692,066, filed on Aug. 22, 2012.

(51) Int. Cl. B60H 1/34

(52) U.S. Cl. CPC B60H 1/34

(57) ABSTRACT

An airflow supply duct for use in a transportation refrigeration trailer is provided including an inlet portion adjacent a first end and an outlet portion adjacent a second opposite end. A generally curvilinear central portion is disposed between the inlet portion and the outlet portion. The inlet portion, the central portion, and the outlet portion form an interior flow path. The airflow supply duct has a rectangular cross-section having an approximately uniform cross-sectional area along a length of the airflow duct. A height and width of the airflow supply duct vary along the length of the airflow supply duct such that a ration of the width to the height at the second end is greater than the ration of the width to the height at the first end.

### BACKGROUND OF THE INVENTION

The invention relates generally to transport refrigeration systems and, more particularly, to an evaporator air management system of a transport refrigeration system.

Transport refrigeration systems are composed of a power system, refrigeration circuiting, air management systems, and a control system, which are all packaged in a unit mounted to a transport device, such as a trailer for example. The air management system circulates air through a load in the trailer and back through the evaporator coil, which subsequently removes heat from the air stream and thereby cools the cargo.

In conventional transport refrigeration systems, the flow distribution of the air discharge from the air management system is dependent on the velocity of the air as well as other flow characteristics. Because the resulting flow distribution is generally non-uniform, the cargo throughout the trailer is not cooled evenly, which may compromise the quality of the cargo. In some transport refrigeration systems, an attachment extends from the supply air discharge, such as a chute or duct for example. These attachments are typically supported by the ceiling and more uniformly distribute the air throughout the length of the trailer. However, the inclusion of a conventional chute or duct in a trailer impedes the loading and unloading of cargo in the trailer, such that the chute or duct is frequently damaged during such processes. The chute or duct may also become fouled with dirt, cargo residue, and other undesirable material. In addition, inclusion of a chute or duct decreases the air discharge supply and negatively impacts the performance of the evaporator air management system.

### BRIEF DESCRIPTION OF THE INVENTION

According to one embodiment of the invention, an airflow supply duct for use in a transportation refrigeration trailer is provided including an inlet portion adjacent a first end and an outlet portion adjacent a second opposite end. A generally curvilinear central portion is disposed between the inlet portion and the outlet portion. The inlet portion, the central portion, and the outlet portion form an interior flow path. The airflow supply duct has a rectangular cross-section having an approximately uniform cross-sectional area along a length of the airflow duct. A height and width of the airflow supply duct vary along the length of the airflow supply duct such that a ration of the width to the height at the second end is greater than the ration of the width to the height at the first end.

According to another aspect of the invention, a transportation refrigeration trailer having a plurality of walls including a front wall and a ceiling, wherein a transportation refrigeration unit is located without one of the plurality of walls and includes a discharge opening facing the interior of the trailer is provided include an airflow supply duct. The airflow supply duct is disposed within the interior of trailer such that a first end is coupled to the transportation refrigeration unit adjacent the discharge opening. The second end of the airflow supply duct is coupled to the ceiling. The airflow supply duct provides at least one flow path for air from the transportation refrigeration unit to the interior of the trailer. The airflow supply duct has a rectangular cross-section having an approximately uniform cross-sectional area along a length of the airflow supply duct. A height and width of the airflow supply duct vary along the length of the airflow supply duct such that a ratio of the width to the height at the second end is greater than the ratio of the width to the height at the first end.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a cross-sectional illustration of an exemplary transport refrigeration trailer;

FIG. 2 is a detailed view of an exemplary transport refrigeration unit;

FIG. 3 is a perspective view of an airflow supply duct according to an embodiment of the invention;

FIG. 4 is a front view of a first end of an airflow supply duct according to an embodiment of the invention;

FIG. 5 is a side view of an airflow supply duct according to an embodiment of the invention;

FIG. 6 is a top view of an airflow supply duct according to an embodiment of the invention;

FIG. 7 is a perspective view of another airflow supply duct according to an embodiment of the invention; and

FIG. 8 is a cross-sectional illustration of a transport refrigeration trailer according to an embodiment of the invention.

### DETAILED DESCRIPTION OF THE INVENTION

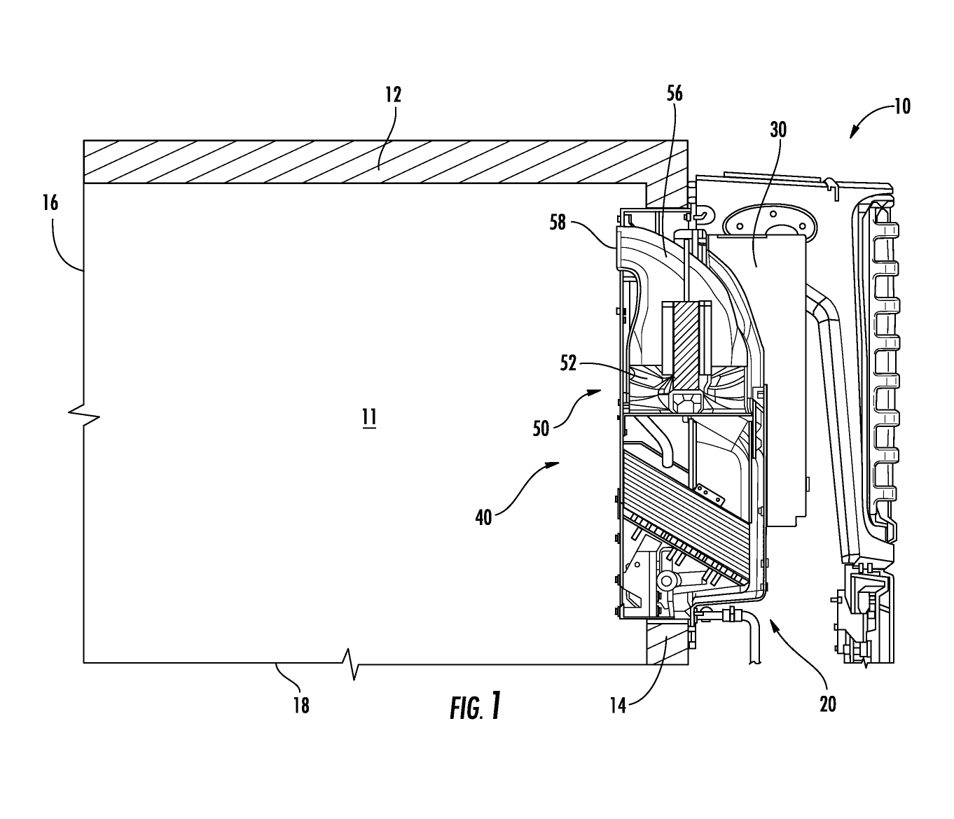

Referring to FIG. 1, a portion of a transport refrigeration trailer 10 is illustrated. The trailer 10 has an interior 11 formed by thermally insulated walls including a top wall 12, front and rear walls 14 and 16, a floor 18, as well as side walls (not shown). A transportation refrigeration unit 20 is mounted at the front of the trailer 10. The transportation refrigeration unit 20 includes an exterior condenser 30 that projects forwardly from the front wall 14 and an interior evaporator section 40 that is disposed within the front wall 14 and projects rearwardly into the interior of the trailer 10.

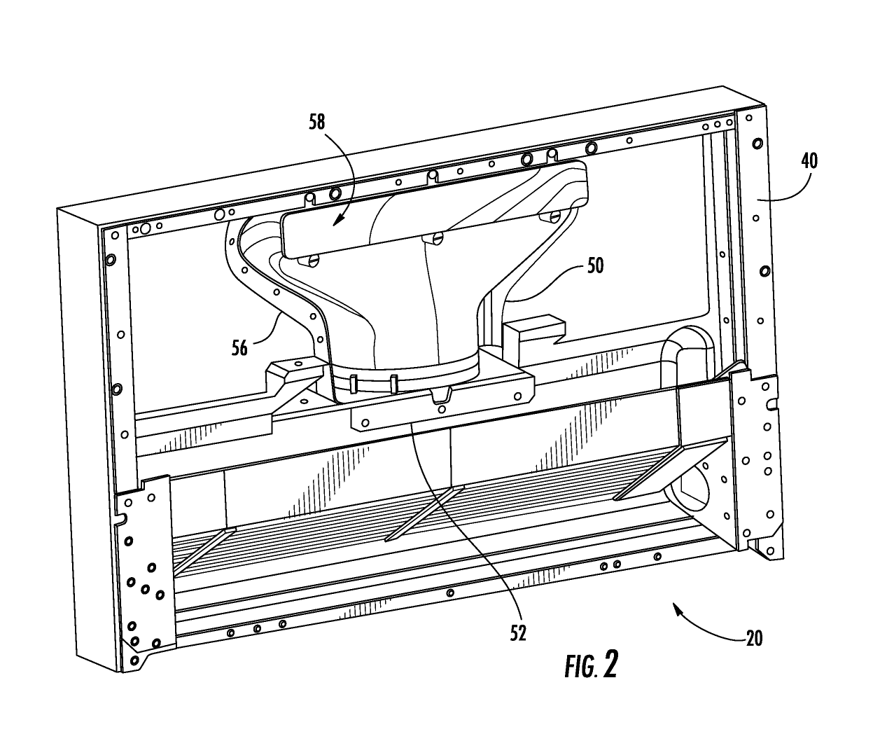

An exemplary evaporator section 40 of the transportation refrigeration unit 20 is illustrated in FIG. 2 in more detail. The evaporator section includes an inlet that receives return air from the interior 11 of the trailer 10. Mounted within the evaporator section 40 is a fan unit 50. A nozzle 56 of the fan and nozzle unit 50 surrounds a portion of the fan 52. The nozzle 56 may turn 90 degrees to an opening 58 facing rearwardly toward the interior 11 of the trailer 10. Cool air from the fan unit 50 is discharged through the opening 58. The transportation refrigeration unit 20 described herein is for illustrative purposes only. Other transportation refrigeration units 20 having an inlet for receiving air from the interior 11 of the trailer 10 and an outlet for discharging air into the interior of the trailer 10 are within the scope of this invention.

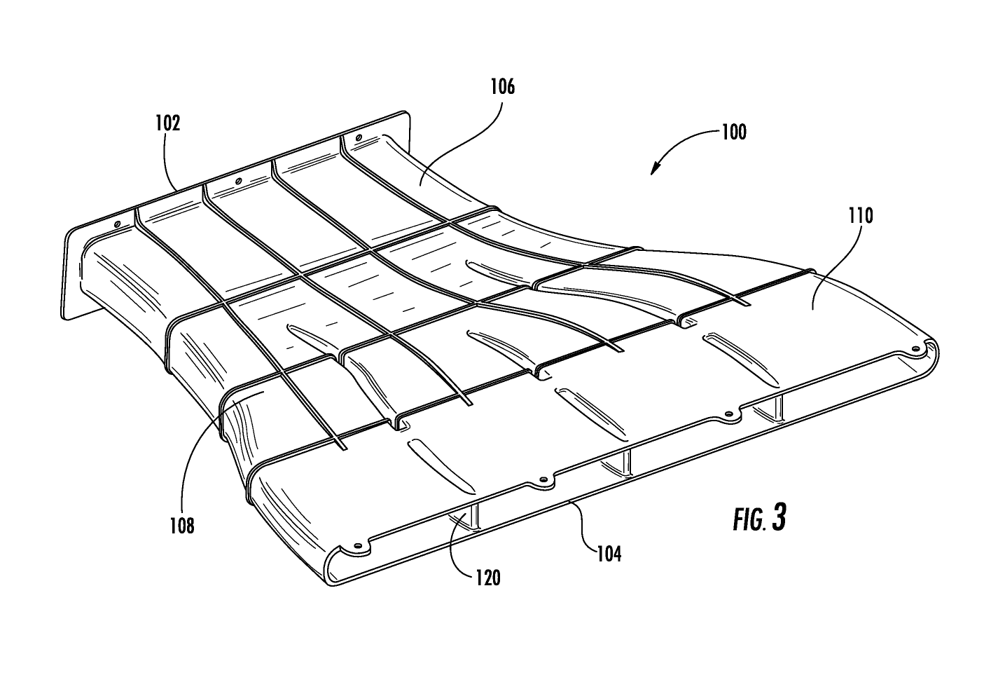

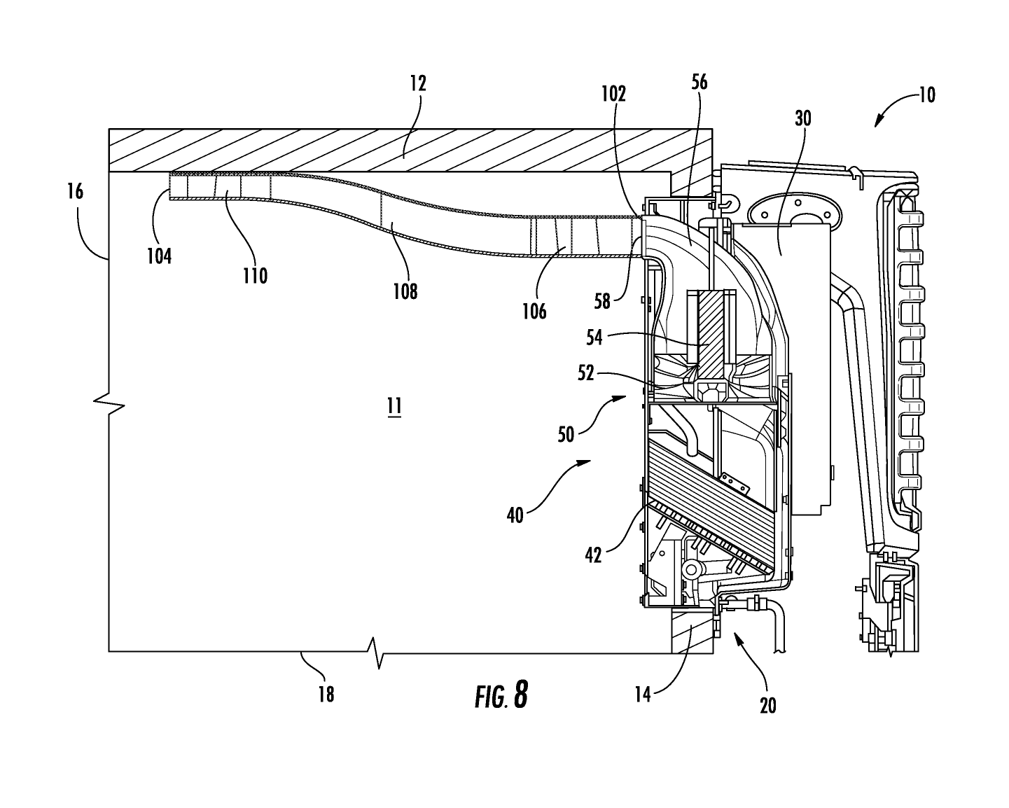

Referring now to FIGS. 3-8, an airflow supply duct 100 may be connected to a portion of the transport refrigeration unit 20 to distribute air from the opening 58 of the evaporator section 40 to the far end of the trailer 10, adjacent the rear wall 16. The airflow supply duct 100 projects from adjacent the front wall 14 at least partially into the interior 11 of the trailer 10. In one embodiment, the airflow supply duct 100 is positioned adjacent the top wall 12.

To circulate air throughout the full length of the trailer 10, the airflow supply duct 100 should have a length L in the range of about 3% to 30% of the length of the trailer 10. In one embodiment, the airflow supply duct 100 has a length L of about 12% of the length of the trailer 10. The airflow supply duct 100 includes a rectangular cross-section having an approximately constant area; the cross-sectional area may have a tolerance of about ±15%. Both the width W and the height H of the airflow supply duct 100 vary along the length L of the airflow supply duct 100, giving the airflow supply duct 100 a thin, wide profile. The width W and height H at the first end 102 are approximately equal to the width and height of the opening 58 of the nozzle 56. The width W gradually increases along the length L of the airflow supply duct 100 to form a generally flared second end 104. The width W at the second end 104 of the airflow supply duct 100 may be in the range of about 35% to 70% of the width of the trailer 10. In one embodiment, the width W of the second end 104 of the airflow supply duct 100 is about 42% of the width of the trailer 10.

The height H of the airflow supply duct 100 decreases from the first end 102 over the length L of the airflow supply duct 100. The height H at the second end 104 of the airflow supply duct 100 may be in the range of about 1% to 4% of the height of the trailer 10. In one embodiment, the second end 104 of the airflow supply duct 100 has a height H that is about 2.8% of the height of the trailer 10. The width W and the height H of the airflow supply duct 100 at both the first end 102 and the second end 104 may also be expressed as a ratio. The width to height (W/H) ratio at the first end 102 of the duct 100 may be in the range of about 1 to about 10. In one embodiment, the width to height (W/H) ratio at the first end 102 is about 6.7. The width to height (W/H) ratio at the second end 104 of the airflow supply duct 100 may be in the range of about 10 to about 20. In one embodiment, the width to height (W/H) ratio at the second end 104 is about 14. By increasing the width to height (W/H) ratio along the length L of the airflow supply duct 100, the second end 104 is oriented for tangential flow along the ceiling 12 of the trailer 10.

The airflow supply duct 100 includes an inlet portion 106 adjacent a first end 102, an outlet portion 110 adjacent a second end 104, and a central portion 108 disposed between the inlet portion 106 and the outlet portion 110. Both the inlet portion 106 and the outlet portion 108 are generally horizontal, such that when the airflow supply duct 100 is connected to the transport refrigeration unit 20, the inlet portion 106 and the outlet portion 110 are parallel to the top wall 12 of the trailer 10. In addition, the first end 102 and the second end 104 are arranged tangentially to the top wall 12 of the trailer 10. The central portion 108 of the airflow supply duct 100 is generally curved such that the plane of the inlet portion 106 is spaced a distance away from the plane of the outlet portion 110. In one embodiment, the curvilinear central portion 108 is generally S-shaped. In one embodiment, the contour of the central portion 108 is such that when the inlet portion 106 is positioned adjacent the opening 58 of the nozzle 56, a surface of the outlet portion 110 is in contact with the top wall 12 of the trailer 10.

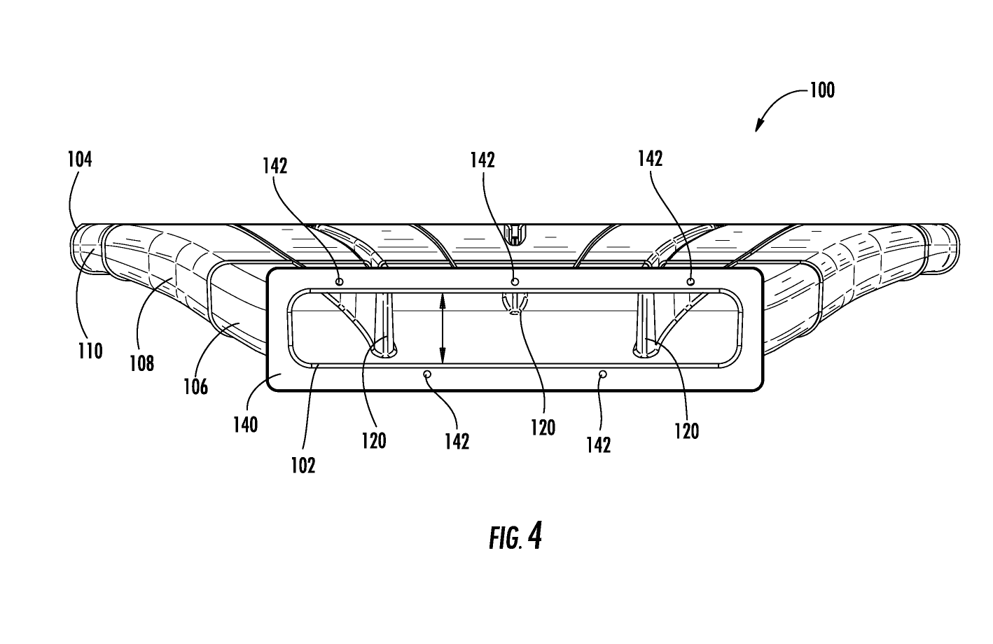

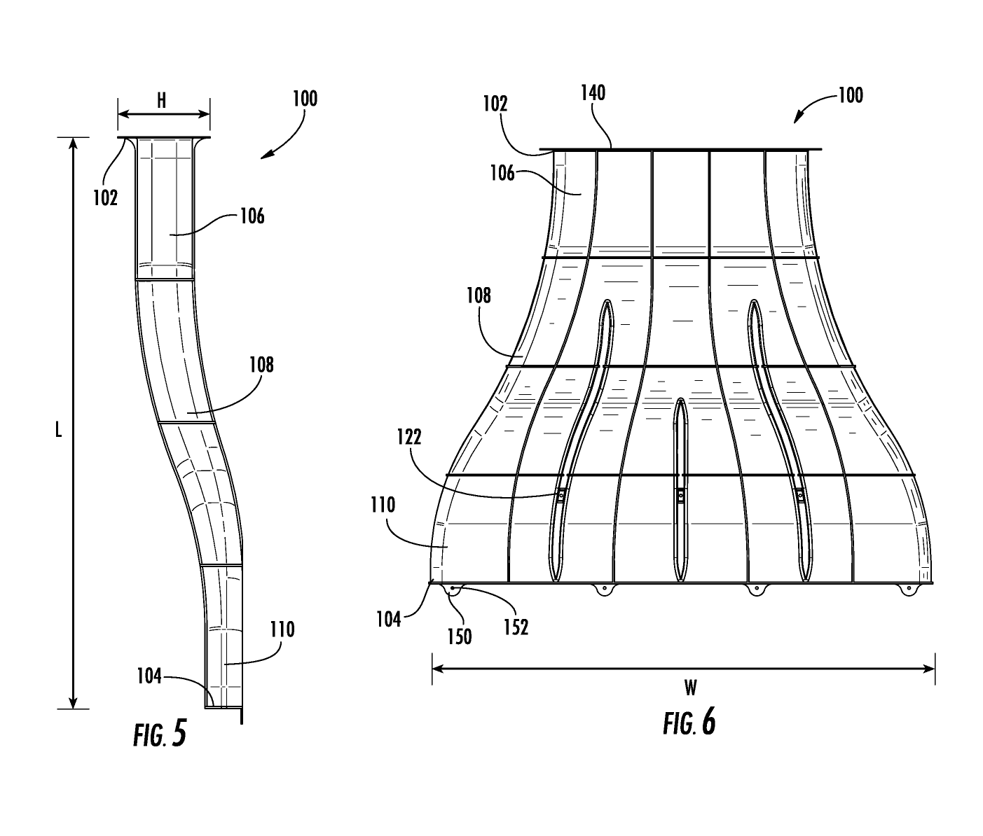

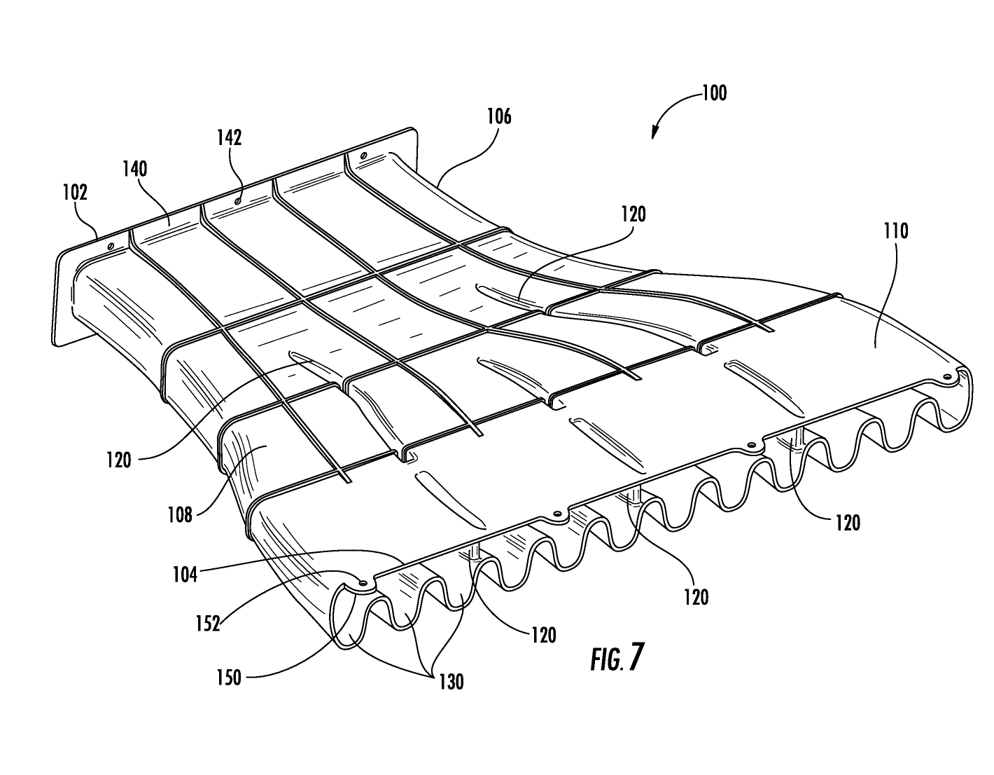

In one embodiment, one or more splitter vanes 120 extend along at least a portion of the length L of the airflow supply duct 100 toward the second end 104 to separate the interior of the airflow supply duct 100 into multiple flow paths (FIGS. 3-4). By including splitter vanes 120, the diffusion and airflow uniformity of the air flowing through the airflow supply duct 100 will improve. In embodiments where the airflow supply duct 100 includes a plurality of splitter vanes 120, the splitter vanes 120 are approximately uniformly spaced across the width W of the airflow supply duct 100. In one embodiment, the splitter vane 120 extends through only the outlet portion 110 and the central portion 108 of the airflow supply duct 100. As illustrated in FIG. 6, the second end 104 of the airflow supply duct 100 may include a plurality of mixer lobes 130, which entrain airflow along a lower edge of the airflow supply duct 100.

The airflow supply duct 100 includes a generally rectangular flange 140, adjacent the first end 102, for mounting the first end 102 near the opening 58 of the nozzle 56. The flange 140 may include a plurality of holes 142 such that fasteners may be used to couple the flange 140 to the evaporator section 40 of the transportation refrigeration unit 20 (see FIG. 8). Similarly, a plurality of small flanges 150 may extend from the second end 104 of the airflow supply duct 100 (see FIGS. 3 and 6). Each small flange 150 may include a hole 152 for connecting the second end 104 of the airflow supply duct 100 to a surface of the trailer 10, such as the top wall 12 for example, with a fastener. In addition, tabs 122 may extend from the exterior of the airflow supply duct 100, above each splitter vane 120, for connecting the outlet portion 110 of the airflow supply duct 110 to the top wall 12 of the trailer 10.

The airflow supply duct 100 may be constructed from a plastic material, such as a medium density polyethylene for example. The inlet portion, outlet portion, and central portion of the airflow supply duct 100 may be formed integrally to give both the interior and the exterior of the airflow supply duct 100 a smooth contour. The airflow supply duct 100 may be constructed as a single piece, or alternatively, as a two piece assembly cut along the length L to form an upper portion and a lower portion. Manufacturing processes for the airflow supply duct 100 include, but are not limited to blow-molding, roto-molding, injection molding, thermoforming and or other similar processes.

The airflow supply duct 100 is more robust than the airflow chutes commonly used with transport refrigeration units 20. Because the airflow supply duct 100 has a thin profile that extends minimally from the ceiling of the trailer 10, the duct 100 occupies less space in the trailer 10 and is less susceptible to damage during loading and unloading. In addition, the shortened length of the duct 100, as well as its connection within the trailer 10 makes it easy to remove and clean. Inclusion of the airflow supply duct 100 also increases the reliability of the transport refrigeration unit 20. The duct 100 produces a strong, stable flow along the ceiling of the trailer 10, resulting in an improved flow distribution and uniformity of cargo temperature without restricting overall airflow. In addition, by improving the uniformity of the cargo temperature, the amount of time that the cargo may spend in the trailer 10 before its quality is compromised is increased.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. An airflow supply duct for use in a transportation refrigeration trailer comprising:
an inlet portion adjacent a first end;
an outlet portion adjacent a second opposite end;
a generally curvilinear central portion disposed between the inlet portion and the outlet portion, wherein the inlet portion, the central portion, and the outlet portion form an interior flow path; and
wherein the airflow supply duct has a rectangular cross-section having an approximately uniform cross-sectional area along a length of the airflow supply duct, and a height and width of the airflow supply duct vary along the length of the airflow supply duct such that a ratio of the width to the height at the second end is greater than the ratio of the width to the height at the first end.

2. The airflow supply duct according to claim 1, wherein the width to height ratio at the second end is in the range of about 10 to about 20.

3. The airflow supply duct according to claim 2, wherein the width to height ratio at the second end is about 14.

4. The airflow supply duct according to claim 1, wherein the approximately uniform cross-sectional area of the airflow supply duct includes a tolerance of about 15%.

5. The airflow supply duct according to claim 1, wherein the airflow supply duct has a length in the range of about 3% to 30% of a length of the transportation refrigeration trailer.

6. The airflow supply duct according to claim 5, wherein the length of the airflow supply duct is about 12% of the length of the transportation refrigeration trailer.

7. The airflow supply duct according to claim 1, wherein the width of the airflow supply duct at the second end is in the range of about 35% to 70% of a width of the transportation refrigeration trailer.

8. The airflow supply duct according to claim 7, wherein the width of the airflow supply duct at the second end is about 42% of the width of the transportation refrigeration trailer.

9. The airflow supply duct according to claim 1, wherein the height of the airflow supply duct at the second end is in the range of about 1% to 4% of a height of the transportation refrigeration trailer.

10. The airflow supply duct according to claim 9, wherein the height of the airflow supply duct at the second end is about 2.8% of the height of the transportation refrigeration trailer.

11. The airflow supply duct according to claim 1, wherein the inlet portion and the outlet portion are generally parallel and spaced apart and the central portion connects the inlet portion and the outlet portion such that the airflow supply duct has a generally smooth contour.

12. The airflow supply duct according to claim 1, further comprising at least one splitter vane extending along at least a portion of the length of the airflow supply duct to define multiple interior flow paths.

13. The airflow supply duct according to claim 1, further comprising a plurality of mixer lobes adjacent the second end.

14. The airflow supply duct according to claim 1, wherein the central portion is generally S-shaped.

15. A transportation refrigeration trailer having a plurality of walls including a front wall and a ceiling wherein a transportation refrigeration unit is located within one of a plurality of walls and includes a discharge opening facing an interior of the trailer, comprising:
an airflow supply duct disposed within the interior of the trailer such that a first end is coupled to the transportation refrigeration unit adjacent the discharge opening, and a second end is coupled to the ceiling, wherein the airflow supply duct provides at least one flow path for air from the transportation refrigeration unit to the interior of the trailer; and
wherein the airflow supply duct has a rectangular cross-section having an approximately uniform cross-sectional area along a length of the airflow supply duct, and a height and width of the airflow supply duct vary along the length of the airflow supply duct such that a ratio of the width to the height at the second end is greater than the ratio of the width to the height at the first end.

16. The transportation refrigeration trailer according to claim 15, wherein the width to height ratio at the second end is in the range of about 10 to about 20.

17. The transportation refrigeration trailer according to claim 16, wherein the width to height ratio at the second end is about 14.

18. The transportation refrigeration trailer according to claim 15, wherein the approximately uniform cross-sectional area of the airflow supply duct includes a tolerance of about 15%.

19. The transportation refrigeration trailer according to claim 15, wherein the airflow supply duct further includes:
an inlet portion adjacent the first end;
an outlet portion adjacent the second opposite end; and
a generally curvilinear central portion disposed between the inlet portion and the outlet portion, wherein the inlet portion, the central portion, and the outlet portion form an airflow supply duct having a generally smooth contour.

20. The transportation refrigeration trailer according to claim 19, wherein the central portion is generally S-shaped.

21. The transportation refrigeration trailer to claim 15, wherein the length of the airflow supply duct is in the range of about 3% to 30% of a length of the trailer.

22. The transportation refrigeration trailer according to claim 15, wherein a width of the airflow supply duct at the second end is in the range of about 35% to 70% of a width of the trailer.

23. The transportation refrigeration trailer according to claim 15, wherein a height of the airflow supply duct at the second end is in the range of about 1% to 4% of a height of the trailer.

24. The transportation refrigeration trailer according to claim 15, further comprising at least one splitter vane extending along at least a portion of the length of the airflow supply duct to define multiple interior flow paths.

25. The transportation refrigeration trailer according to claim 15, further comprising a plurality of mixer lobes adjacent the second end.
